(19) United States
(12) Patent Application Publication
(10) Pub. No.: US 2005/0040161 A1
(43) Pub. Date: Feb. 24, 2005

(54) Microwaveable food package

(76) Inventors: David Lin, Shanhua (TW); Irene Lin, Shanhua (TW)

Correspondence Address: Alan D. Kamrath;Rider Benneth, LLP, Suite 2000, 333 South Seventh Street, Minneapolis, MN, 55402, US

(21) Appl. No.: 10/645,380

(22) Filed: Aug. 21, 2003

(51) Int. Cl. H05B 6/80

(52) U.S. Cl. 219/725; 219/731

(57) ABSTRACT

Microwaveable food package and method of manufacturing the same are disclosed. The package comprises an airtight food region, a reversible vapor pressure regulating region, and a passage at a junction between both regions. The passage is airtight sealed in a nonoperating state. Whereby heating the food region with a foodstuff contained therein will increase a vapor pressure in the food region, swell the food region, open up the passage, direct hot steam to the pressure regulating region from the food region via the passage for releasing excessive pressure, swell the pressure regulating region, and cause hot steam to be automatically regulated by the pressure regulating region. Further, after heating stops, the cooling process will cause both swelled regions to contract, and return both regions to their original states. The package can be a container or bag.

### BACKGROUND OF THE INVENTION

1. Field of the Invention

The present invention relates to microwaveable food packaging and more particularly to a microwaveable food package (e.g., container or bag) and a method of manufacturing the same.

A frozen or refrigerated food package heated by microwaving is embodied by the present invention. In which there is no need of tearing the food package or punchuring holes therethrough prior to microwave heating. During microwaving, hot vapor thus generated inside the airtight food package will pass an airtight sealed passage having a relative low adhesion strength into the vapor pressure regulating region of an abutted reversible vapor pressure regulating film for pressure regulation. By utilizing the present invention, food contained in the container or bag can be fully cooked by circulating hot vapor generated by microwaving in a closed packaging. During microwaving, high pressure inside the container or bag is appropriately regulated for preventing the container or bag from bursting. As an end, hot vapor can be fully utilized and it is possible of avoiding lost of moisture from the food being overcooked and becoming hard and dry.

2. Description of Related Art

Microwaveable bags, containers and wrapping films are used as packaging materials for microwave heating. The material is typically selected from a group consisting of polyethylene (PE), polypropylene (PP), polycarbonate (PC), polyvinyl chloride (PVC), polyvinylidene chloride (PVDC), polymethylpentene (PMP), ethylene-ninyl acetate (EVA), nylon, polyurethane (PU), polyethylene terephthalate (PET), polyvinyl alcohol (PVA), biodegradable materials, etc. or a combination of the above mentioned materials.

For facilitating the manufacturing of the above packaging materials, the manufacturer may add certain plasticizer additives. The direct contact of these additives with the food product during storage, shipping and/or microwave heating may contaminate the food and have a negative impact on the health of the consumer.

For example, Food and Drug Administration (FDA) of USA is setting strict requirements to regulate food packaging materials. In addition to the basic requirement that food products should not be contaminated by the packaging materials, standards such as the resistance of the migration of harmful species from packaging material at high and/or low temperatures have also been stipulated.

When microwaving a food product in an airtight packaging material, the rapid increase of temperature and vapor pressure may lead to the bursting of the packaging material. When this occurs, the food will lose its water content quickly, and in turn the food will become hard and dry. In order to avoid bursting, many packaging suppliers recommend piercing that packaging material before heating in the microwave oven to release excessive pressure and hot steam. However, the piercing of the material will also allow volatile components to escape. As an end, the food will dry out and lose its wholesomeness.

Techniques for releasing excessive pressure while microwaving a food product have been known. For example, SC Johnson Company developed a zipper bag “Ziploc” for frozen food packaging. In use, a user is advised to open a vent for releasing excessive pressure while microwaving a food product, thereby avoiding bursting. However, the drawbacks of drying out the food and losing its wholesomeness are found.

Another drawback of the zipper bag “Ziploc” is that its material is polyethylene and it is formed via blown extruding process. Polyethylene is characterized by its high airtightness, low mechanical strength, and very high elongation under high temperature environment. Bursting may occur with a tightly sealed “Ziploc” bag having food contained therein and being heated in a microwave oven because “Ziploc” cannot withstand high temperature and high vapor pressure. Moreover, because of low melting point of polyethylene, “Ziploc” bags may melt, leaving an unpleasant wax smelling. As an end, heated vapor is escaped and thus the food may become hard and dry.

For solving the problem of bursting, considerable research and experimentation have been made by packaging converters. As such, a variety of air permeable food containers and bags have been commercially available. Such food containers and bags for containing frozen or refrigerated food are advantageous since there is no need of tearing it prior to microwaving. However, they are also disadvantageous for being short in the time period of preservation. Particularly, vacuum packaging, carbon dioxide (CO2), nitrogen (N2), or any of other inert gases cannot be employed in a modified atmosphere packaging (MAP) processing for prolonging the time period of preservation (i.e., unable to maintain wholesomeness of food).

A continuous improvement and new inventions has been pursued through an intense research and development. A Taiwanese Patent Published No. 522,123 entitled “Method for Manufacturing a Packaging Bag” disclosed an air permeable composite material as food packaging. Drawbacks associated with well-known air permeable materials are eliminated by the air permeable composite material in the said invention. Moreover, the air permeable composite material has advantages such as high energy efficiency, less heating time, ease of use, preservation of moisture content in foods, no splattering during microwave heating, reducing the consumption of water in cleaning the food packaging and the oven. Most importantly, the air permeable composite material is a reversible vapor pressure regulating material. Thus, a food packaging made of the air permeable composite material is a closed package prior to microwaving. During microwaving, the food packaging is able to regulate vapor pressure inside the food packaging by opening up a plurality of pseudo-closed gaps of the food packaging for preventing the food packaging from bursting. Those pseudo-closed gaps have adjacent edges, which are physically contacting to each other. When microwaving stops, those gaps will gradually seal again as the vapor pressure decreases. The food packaging is thus reusable due to the temperature and pressure dependent properties of the reversible vapor pressure regulating material thereof. This is a contrast to the disposable well-known food packaging which requires a user to open the food packaging or tear the food packaging for forming an opening prior to microwaving a food.

In addition, the microwaveable zipper bag formed of a reversible vapor pressure regulating material as disclosed by the Taiwanese Patent comprises an air permeable film having a plurality of pseudo-closed gaps on all of its surface or a portion thereof, and an integrated zipper profile on the film. The zipper profile can be integrated to film by means of a heat sealing or ultrasonic sealing process. The zipper profile of microwaveable reclosable zipper bag needs to be tightly closed in order to form a completely closed package prior to microwaving. Thus, hot vapor generated by microwaving can be automatically regulated without bursting and circulated quickly throughout the internal space of the bag without significant energy loss. This also has benefit of shortening the time required for cooking.

However, there are still rooms for new diversified applications. For example, some fluid in liquid type foods may migrate through the packaging material due to external squeezing pressure. For solving this problem, liquid type food is typically put on a microwave dish. Moreover, for prolonging the wholesomeness of food, vacuum packaging or the packaging filled with CO₂, N₂, or any of other inert gases is required for implementing a modified atmosphere packaging (MAP). More desirably, a plastic material such as nylon having the airtight property is selected as the material for manufacturing bags. In view of the above, continuing improvements in the exploitation of microwaveable food package are constantly being sought.

### SUMMARY OF THE INVENTION

It is an object of the present invention to provide a microwaveable container, comprising a food compartment including an airtight film covered thereon; a pressure regulating compartment including an reversible vapor pressure regulating film sealed thereon; and at least one passage assembly at a junction between the food compartment and the pressure regulating compartment, the passage assembly being sealed at a sealing strength lower than the sealing strength along the microwaveable container edges in a nonoperating state, thus MAP or vacuum package of frozen and refrigerated food is allowed in the food compartment, whereby heating the food compartment with a foodstuff contained therein will increase vapor pressure of hot steam generated by evaporating water in the foodstuff, swell the airtight film, opening up the sealed passage assembly, direct hot steam to the pressure regulating compartment from the food compartment via the passage assembly for releasing excessive pressure, swell the reversible vapor pressure regulating film, and cause hot vapor pressure to be automatically regulated without bursting the film; when the heating stops, the cooling process will cause both the swelled airtight film and the swelled vapor pressure regulating film to contract, and restore both the food compartment and the pressure regulating compartment to their original states.

It is another object of the present invention to provide a microwaveable bag, comprising: an airtight food pocket the airtight food pocket including an airtight film; a pressure regulating pocket, the pressure regulating pocket including a reversible vapor pressure regulating film; and at least one passage assembly at a junction between the food pocket and the pressure regulating pocket, the passage assembly being sealed at a sealing strength lower than the sealing strength along the microwaveable bag edges in a nonoperating state, thus MAP or vacuum package of frozen and refrigerated food is allowed in the food pocket, whereby heating the food pocket with a foodstuff contained therein will increase vapor pressure of hot steam generated by evaporating water in the foodstuff, swell the food pocket, open up the sealed passage assembly, direct hot steam to the pressure regulating pocket from the food pocket via the passage assembly for releasing excessive pressure, swell the pressure regulating pocket, and cause hot vapor pressure to be automatically regulated without bursting the pocket; when the heating stops, the cooling process will cause both the swelled airtight pocket and the swelled vapor pressure regulating pocket to contract, and gradually restore both the food pocket and the pressure regulating pocket to their original states.

It is still another object of the present invention to provide a method of manufacturing microwaveable package, comprising the steps of (a) forming a food region including an airtight film thereon; (b) forming a pressure regulating region including a reversible vapor pressure regulating film thereon; and (c) applying an adhesive material of weak heat sealing strength on a junction between the food region and the pressure regulating region for forming a potential passage assembly which is airtight sealed in a nonoperating state whereby heating the food region with a foodstuff contained therein will increase a vapor pressure of hot steam generated by evaporating water in the foodstuff, swell the airtight film, opening up the passage assembly, direct hot steam to the pressure regulating region from the food region via the passage assembly for releasing excessive pressure, swell the reversible vapor pressure regulating film, and cause hot vapor pressure to be automatically regulated without bursting the film; when the heating stops, the cooling process will cause both the swelled airtight film and the swelled vapor pressure regulating film to contract, and gradually restore both the food film and the pressure regulating film to their original states.

The above and other objects, features and advantages of the present invention will become apparent from the following detailed description taken with the accompanying drawings.

### BRIEF DESCRIPTION OF THE DRAWINGS

FIG. 1 is a perspective view of a microwaveable container according to a first preferred embodiment of the invention where food is put in a food compartment;

FIG. 2 is a cross-sectional view of FIG. 1;

FIG. 3A is a view similar to FIG. 2 where hot steam is generating from the food while heating;

FIG. 3B is a view similar to FIG. 3A where hot steam is further directed to a pressure regulating compartment from the food compartment via a passage assembly;

FIG. 4A is a view similar to FIG. 2 where the passage assembly is closed again due to removal of heat;

FIG. 4B is a view similar to FIG. 2 where both food compartment and pressure regulating compartment completely return to their original states after heat has been removed for a period of time;

FIG. 5 is a perspective view of a microwaveable bag according to a second preferred embodiment of the invention where food is put in a food pocket;

FIG. 6 is a cross-sectional view of FIG. 5;

FIG. 7A is a view similar to FIG. 6 where hot steam is generating from the food while heating;

FIG. 7B is a view similar to FIG. 7A where hot steam is further directed to a pressure regulating pocket from the food pocket via a passage assembly;

FIG. 8A is a view similar to FIG. 6 where the passage assembly is closed again due to removal of heat; and

FIG. 8B is a view similar to FIG. 6 where both the food pocket and the pressure regulating pocket completely return to their original states after heat has been removed for a period of time.

### DETAILED DESCRIPTION OF THE PREFERRED EMBODIMENTS

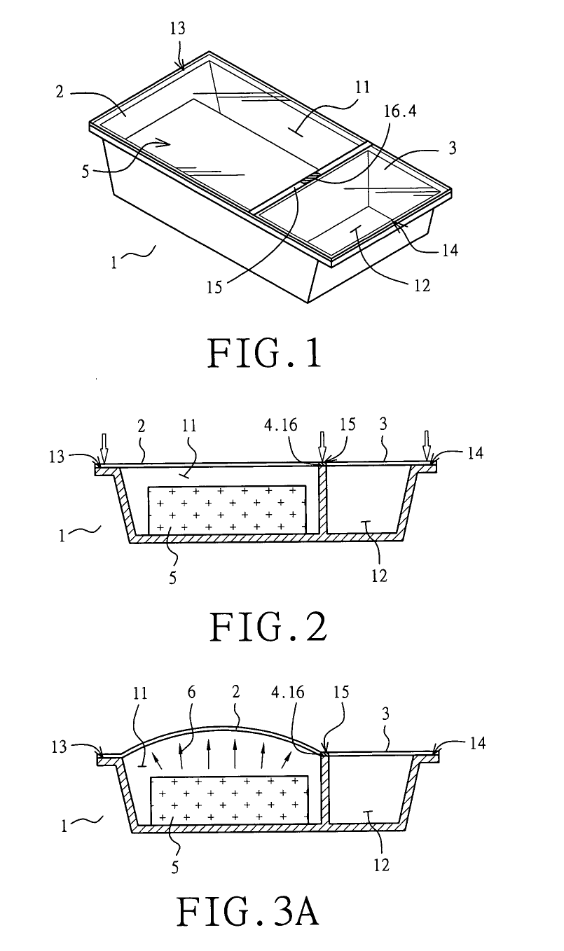

Referring to FIGS. 1 and 2, there is shown a first preferred embodiment of the invention. A microwaveable container 1 comprises a food compartment 11 and an abutted pressure regulating compartment 12. An airtight film 2 is covered on a top periphery 13 of the food compartment 11. Further, the food compartment 11 is sealed by the airtight film 2 by applying adhesive material or heat sealing (e.g., ultrasonic sealing). Also, an reversible vapor pressure regulating film 3 is covered on a top periphery 14 of the pressure regulating compartment 12. Further, the pressure regulating compartment 12 is sealed by the reversible vapor pressure regulating film 3 by applying adhesive material or heat sealing (e.g., ultrasonic heat sealing). In the embodiment, a passage 16 is formed on a junction between the food compartment 11 and the pressure regulating compartment 12. Note that the passage 16 is airtight sealed in a nonoperating state. The forming of the passage 16 may be carried out by one of three techniques detailed below. First one is that a polymer layer of low adhesion strength is applied on the junction 15. The polymer layer is selected either from a group consisting of polyacrylic, polyester, polyamide, rubber, hot melt elastomer, silicone elastomer, ionomer, thermoplastics, and surfactant or a combination thereof. Preferably, the polymer layer has the properties of heat resistant and nontoxic. In practice, the passage 16 is formed by printing, hot melt coating, or laminating the polymer layer on the junction 15. Second one as implemented in the embodiment is that an adhesive material 4 of low adhesion strength is applied on the junction 15. Third one is that a passage at a junction having lower heat sealing strengths is formed. A lower heat sealing temperature will have lower heat sealing strength due to a lower degree of material diffusion along the passage surface. The passage will be opened when heat is applied to film 2.

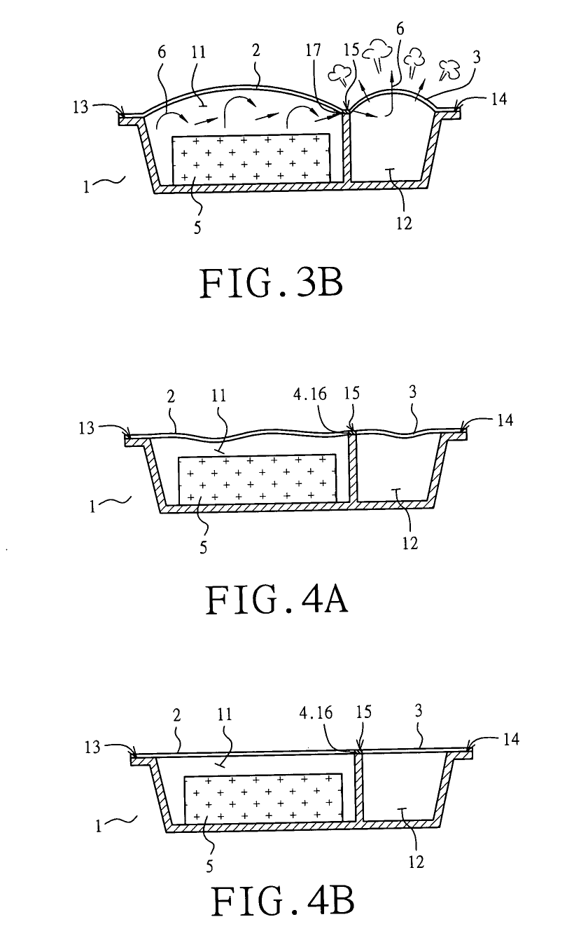

Referring to FIGS. 3A and 3B, a heating process of the embodiment is detailed below. When heat is applied to the container 1 with food 5 put in the food compartment 11, vapor pressure of hot steam 6 generated by evaporating water in the food 5 is increased gradually. The airtight film 2 gradually swells during the heating process. Next, the passage 16 opens up gradually. Further, hot steam 6 is directed to the pressure regulating compartment 12 from the food compartment 11 via the passage 16 for releasing excessive pressure when the pressure of hot steam 6 in the food compartment 11 is excessive. Furthermore, the reversible vapor pressure regulating film 3 gradually swells. Moreover, hot steam 6 is automatically regulated by the reversible vapor pressure regulating film 3 by releasing excessive pressure in the pressure regulating compartment 12 to prevent bursting of the reversible vapor pressure regulating film 3.

Referring to FIGS. 4A and 4B, a cooling process of the embodiment is detailed below. When heat is no longer applied to the container 1, the swelled airtight film 2 and the swelled vapor pressure regulating film 3 contract gradually. As an end, both the food compartment 2 and the pressure regulating compartment 3 completely return to their original states after heat has been removed (i.e., cooled) for a period of time. That is, both the food compartment 2 and the pressure regulating compartment 3 are closed again. This feature can preserve wholesomeness of the food 5 and prevent foreign objects from entering to contaminate the food 5.

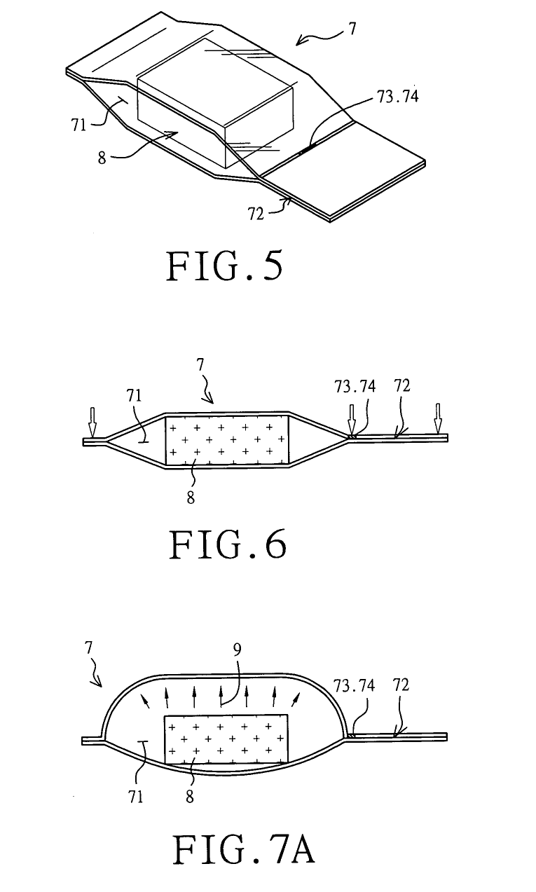

Referring to FIGS. 5 and 6, there is shown a second preferred embodiment of the invention. A microwaveable bag 7 comprises a food pocket 71 and an abutted pressure regulating pocket 72 which is substantially completely sealed, flat in a nonoperating state and has a reversible vapor pressure regulating film. The food pocket 71 is maintained airtight in a nonoperating state. In the embodiment, a passage 73 is formed on a junction between the food pocket 71 and the pressure regulating pocket 72. Note that the passage 73 is airtight closed in a nonoperating state. The forming of the passage 73 may be carried out by one of three techniques detailed below. First one is that a polymer layer of low adhesion strength is applied on the junction. The polymer layer is selected either from a group consisting of polyacrylic, polyester, polyamide, rubber, hot melt elastomer, silicone elastomer, ionomer, thermoplastics, and surfactant or a combination thereof. Preferably, the polymer layer further has the properties of heatproof and nontoxic. In practice, the passage 73 is formed by printing, hot melt coating, or laminating the polymer layer on the junction. Second one as implemented in the embodiment is that an adhesive material 74 of low adhesion strength is applied on the junction. Third one is that a passage at a junction having lower heat sealing strengths is formed. A lower heat sealing temperature will have lower heat sealing strength due to a lower degree of material diffusion along the passage surface. The passage 73 will be opened when heat is applied to the food pocket 71.

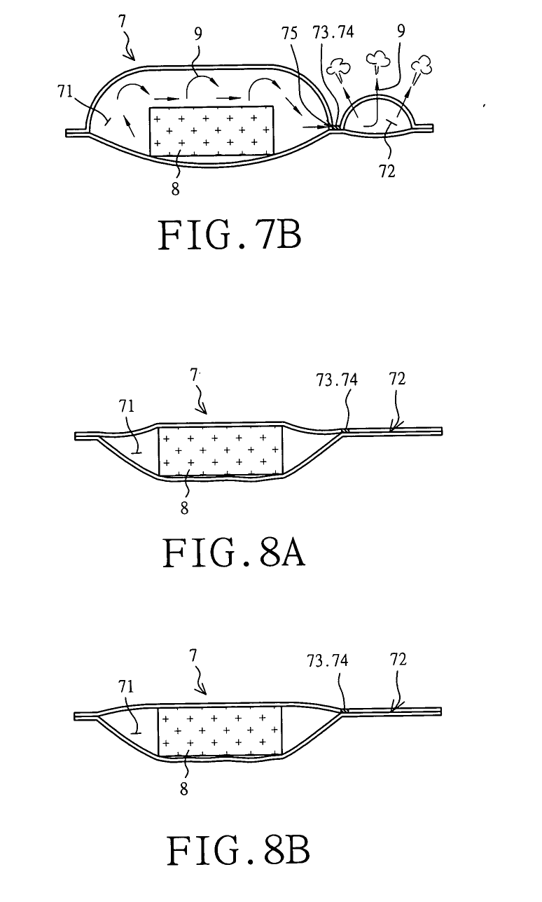

Referring to FIGS. 7A and 7B, a heating process of the embodiment is detailed below. When heat is applied to the bag 7 with food 8 put in the food pocket 71, vapor pressure of hot steam 9 generated by evaporating water in the food 8 is increased gradually. The airtight food pocket 71 gradually swells during the heating process. Next, the passage 73 opens up gradually. Further, hot steam 9 is directed to the pressure regulating pocket 72 from the food pocket 71 via the passage 73 for releasing excessive pressure when the pressure of hot steam 9 in the food pocket 71 is excessive. Furthermore, the pressure regulating pocket 72 gradually swells the reversible vapor pressure regulating film thereof. Moreover, hot steam 9 is automatically regulated by the reversible vapor pressure regulating film of the pressure regulating pocket 72 to release excessive pressure in the pressure regulating pocket 72 to avoid bursting.

Referring to FIGS. 7A and 7B, a cooling process of the embodiment is detailed below. When heat is no longer applied to the bag 7, the swelled food pocket 71 and the swelled pressure regulating pocket 72 contract gradually. As an end, both the food, pocket 71 and the pressure regulating pocket 72 are completely returned to the original state after heat has been removed (i.e., cooled) for a period of time. This feature can preserve wholesomeness of the food 8 and prevent foreign objects from entering to contaminate the food 8.

While the invention herein disclosed has been described by means of specific embodiments, numerous modifications and variations could be made thereto by those skilled in the art without departing from the scope and spirit of the invention set forth in the claims.

1. A microwaveable container, comprising:
a food compartment including an airtight film covered thereon;
a pressure regulating compartment including an reversible vapor pressure regulating film sealed thereon; and
a passage assembly at a junction between the food compartment and the pressure regulating compartment, the passage assembly being airtight closed in a nonoperating state,
whereby heating the food compartment with a foodstuff contained therein will increase a vapor pressure of hot steam generated by evaporating water in the foodstuff, swell the airtight film, opening up the passage assembly, direct hot steam to the pressure regulating compartment from the food compartment via the passage assembly for releasing excessive pressure, swell the reversible vapor pressure regulating film, and cause hot steam to be automatically regulated by the reversible vapor pressure regulating film; and during cooling, the food compartment will cause the swelled airtight film and the swelled vapor pressure regulating film to contract, and return the food compartment and the pressure regulating compartment to their original states
wherein the foodstuff is heated by means of radiation, when the vapor pressure exerted by the hot steam inside both the dosed food compartment and the pressure regulating compartment is greater than the vapor pressure outside the vapor pressure regulating film, the heated vapor will inflate the pressure regulating compartment, and open up the pseudo-dosed tiny gaps gradually, and the hot vapor pressure can be automatically regulated through the pressure deformed and enlarged pseudoclosed gaps along the vapor pressure regulating film within the pressure regulating compartment; on the other hand, when the heating source is removed, the temperature and the vapor pressure inside the closed food compartment and the pressure regulating compartment are decreasing and the sealing ability of the pseudo-closed gaps along the vapor pressure regulating film is gradually restored when cooled; the self-venting ability is reversibly functional of pressure difference.

2. The microwaveable container of claim 1, wherein a forming of the passage assembly is carried out by applying a polymer layer of low adhesion strength on the junction, applying an adhesive material of low adhesion strength on the junction, or applying a lower heat sealing temperature on the junction.

3. The microwaveable container of claim 2, wherein the polymer layer is selected either from a group consisting of polyacrylic, polyester, polyamide, rubber, hot melt elastomer, silicone elastomer, ionomer, thermoplastics, and surfactant or a combination thereof.

4. A microwaveable bag, comprising:
afood pocket, including an airtight film;
a pressure regulating pocket substantially completely sealed, the pressure regulating pocket including a reversible vapor pressure regulating film; and
a passage assembly at a junction between the food pocket and the pressure regulating pocket, the passage assembly being airtight closed in a nonoperating state, whereby heating the food pocket with a foodstuff contained therein will increase a vapor pressure of hot steam generated by evaporating water in the foodstuff, swell the food pocket, open up the passage assembly, direct hot steam to the pressure regulating pocket from the food pocket via the passage assembly for releasing excessive pressure, swell the pressure regulating pocket, and cause hot steam to be automatically regulated by the reversible vapor pressure regulating film; and during cooling, the food pocket will cause the swelled food pocket and the swelled pressure regulating pocket to contract, and return the food pocket and the pressure regulating pocket to their original states.

5. The microwaveable bag of claim 4, wherein a forming of the passage assembly is carried out by applying a polymer layer of low adhesion strength on the junction, applying an adhesive material of low adhesion strength on the junction, or applying a lower heat sealing temperature on the junction.

6. The microwaveable bag of claim 5, wherein the polymer layer is selected either from a group consisting of polyacrylic, polyester, polyamide, rubber, hot melt elastomer, silicone elastomer, ionomer, thermoplastics, and surfactant or a combination thereof.

7. A method of manufacturing microwaveable package, comprising the steps of:
(a) forming a food region including an airtight film covered thereon;
(b) forming a pressure regulating region including an reversible vapor pressure regulating film sealed thereon; and
(c) applying an adhesive material of weak heat sealing strength on a junction between the food region and the pressure regulating region for forming a passage assembly which is airtight closed in a nonoperating state
whereby heating the food region with a foodstuff contained therein will increase a vapor pressure of hot steam generated by evaporating water in the foodstuff, swell the airtight film, opening up the passage assembly, direct hot steam to the pressure regulating region from the food region via the passage assembly for releasing excessive pressure, swell the reversible vapor pressure regulating film, and cause hot steam to be automatically regulated by the reversible vapor pressure regulating film; and during cooling, the food region will cause the swelled airtight film and the swelled vapor pressure regulating film to contract, and return the food region and the pressure regulating region to their original states.

8. The method of claim 7, wherein the forming of the passage assembly in the step (c) is done by heating, pressing, or ultrasonic heat sealing.

9. The method of claim 7, wherein the adhesive of weak heat sealing strength in the step (c) is selected either from a group consisting of polyacrylic, polyester, polyamide, rubber, hot melt elastomer, silicone elastomer, ionomer, thermoplastics, and surfactant or a combination thereof.

10. The method of claim 7, wherein the forming of the passage assembly in the step (c) is done by forming a plurality of gaps on the junction between the food region and the pressure regulating region and applying an adhesive of weak heat sealing strength on the passage so that heating the food region will open up the passage assembly and direct hot steam to the pressure regulating region from the food region via the passage assembly for releasing excessive pressure.

11. The method of claim 7, wherein the microwaveable package is a container or bag.
